(19) United States
(12) Patent Application Publication
(10) Pub. No.: US 2007/0150111 A1
(43) Pub. Date: Jun. 28, 2007

(54) Embedded network-controlled omni-directional motion system with optical flow based navigation

(76) Inventors: Li-Wei Wu, Taipei City (TW); Jung-Hung Cheng, Changhua City (TW); Yung-Jung Chang, Taichung City (TW); Jwu-Sheng Hu, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/370,929

(22) Filed: Mar. 9, 2006

(30) Foreign Application Priority Data
Nov. 4, 2005 (TW) 94138828

(51) Int. Cl. G06F 19/00

(52) U.S. Cl. 700/258; 700/245

(57) ABSTRACT

The present invention discloses an embedded network-controlled omni-directional motion system with optical flow based navigation, wherein multiple motion units and at least one embedded network control system are installed to the body, and at least one optical flow sensor is installed on the ground-facing surface of the body. The movement of the body is driven by the motion units, and the motion unit has an omni-directional wheel and a motor device. The optical flow sensors detect the state of motion and create optical-flow detection data. The embedded network control system exchanges motion control instructions and optical-flow detection data with an external information-processing unit via a communication network. Further, the motion system of the present invention may also connect with peripheral control devices to increase the control convenience of the system. As the system of the present invention adopts an optical flow based navigation technology, the system of the present invention can be free from the influence of wheel sliding, environmental variation, and accumulated errors and can achieve accurate navigation.

### BACKGROUND OF THE INVENTION

1. Field of the Invention

The present invention relates to an embedded network-controlled omni-directional motion system, particularly to an embedded network-controlled omni-directional motion system with optical flow based navigation.

2. Description of the Invention

In the 21st century, population aging becomes more and more serious in the developing and developed nations. According to the statistic by the United Nations, the total aged population will reach 2 billions in 2025. Further, the birth rate in developing and developed nations also becomes lower and lower. The aging of society and the reduction of productive population not only will cause social, economic, consumption-behavior transformation but also will dominate the future development of the world. Owing to the abovementioned trend, it is expected that the robotic age in science fiction will really appear in our world. In fact, the robot-related technologies, such as artificial intelligence and sensing technologies, have advanced obviously in the pass decade. Many nations and organizations have predicted the optimistic future of robotic industry, and regard it as the next-generation key industry.

As early as in 1984, ISO (International Organization for Standardization) had proposed a definition of robot: the robot is a programmable machine and can operate and move automatically. In 1994, the terminology of industrial robots by ISO further proposed: a robot should comprise: manipulators, actuators, and a control system (including hardware and software). Generally speaking, a robotic system should have robots, end effectors, robot-related equipments and sensors, and a monitoring/operation-related communication interface. Briefly speaking, a robot executes a specified or unspecified program stored in the memory device thereof according to the instructions of position coordinate, speed, end effector's grasp action, etc. In the mechanism of a robot, actuators are the basic elements and cooperate with linkages and gear trains to execute the instructions issued by the sub-system of the control system (the control unit). The actuators may be pneumatic systems, hydraulic systems, or motors; however, what the current industrial robots adopt is primarily AC or DC motor, including servo motors and stepping motors. Via the instruction box or host computer, the operator can input the control instructions, which are based on the world coordinate, to execute basic control actions or configured intelligent actions. Further, the robot can also utilize tactile sensors or visual sensors to provide protection function, which is needed by the robot when it executes precision-control programs.

The current robots are usually driven with wheels. However, a wheel-driven robot is a system easily influenced by wheel sliding. When a robot undertakes a navigation control, the mathematical model of the system may be obviously influenced by parametric variation, especially the longitudinal velocity. In the general navigation method of a wheel-driven robot, the difference between the preset direction and physically measured direction is used as a controlling offset, and the controller outputs a control value corresponding the difference to adjust the deflection angle of the front wheels. The navigation of wheel-driven robots correlates with many factors, including: longitudinal velocity, transverse velocity, front-wheel deflection angle, rotational inertia with respect to it gravity center, and the position of the gravity center. However, what the conventional navigation method considers is only the difference between the preset direction and physically measured direction and excludes the influence of other factors; therefore, the convention navigation method is hard to achieve satisfactory control effect.

The parameters of the navigation system of the wheel-driven robot are often influenced by the sudden change of some special parameters, and then, the parameters should be reset once more; for example, in a wheel-driven robot using PID controllers (Proportional Integrated Differential Controller), even a slight longitudinal-velocity variation also requires the reset of PID control parameters; otherwise, the control effect may be influenced. The conventional navigation method of the wheel-driven robot can easily control the robot even when it passes through a curved road or a sharp turn at a given speed; however, the positioning error will be enlarged or oscillates owing to the variation of speed, and finally the error will be accumulated to an obvious level.

In order to enhance the dexterity of robots, an omni-directional wheel technology has been developed to replace the conventional wheel-driving technology. Via the omni-directional wheel, the robot not only can make a turn in a narrower space but also can rotate in situ; thus, the robot has higher motion dexterity. The omni-directional wheel is characterized in that multiple elliptic rollers surround the periphery of a wheel axle with the angle contained by the roller's axis and the wheel axle's plane being adjustable. The function of the rollers is to transform the force vertical to the wheel axle, which is generated during the wheel's rotation, into the force parallel to the wheel axle; thus, when the robot undertake navigation control, the influence on the longitudinal velocity can be diminished. The conventional wheel-driven robot needs considerable space to translate and rotate simultaneously; further, it is impossible for the conventional wheel-driven robot to rotate in situ or to directly sideward translate. However, all the abovementioned problems can be overcome by the omni-directional wheel.

To achieve dexterous motion performance, in addition to the improvement of the wheel design, either the convention wheel-driven robot or the omni-direction wheel-driven robot needs high-precision navigation system, especially the household robot. The household robot not only needs high motion accuracy but also requires low cost, easy operation, and high motion dexterity. Nevertheless, the navigation systems of the conventional wheel-driven robot and the omni-direction wheel-driven robot often encounter the following problems:
(1) Odometer of the robot guide wheel (i.e. the so-called optical encoder wheel): the main drawback of the optical encoder wheel is that it will accumulate the errors caused by the wheel sliding; therefore, a high-precision optical encoder wheel is needed; thus, the cost of the robot is raised;
(2) Inertial navigation equipment (including: gyroscope, accelerometer, and angular speedometer): the main drawback of the inertial navigation equipment is that the integration errors will be accumulated; further, the price of the inertial navigation equipment rises drastically with its accuracy;
(3) Vision navigation system: the most common vision navigation system is ERSP (Evolution Robotics Software Platform); the vision navigation system needs a CCD (Computer-Controlled Device) and a calculation platform; the information amount thereof is great, and the calculation is also very complicated; further, visual sensation itself is easily influenced by various factors, such as the brightness variation, shielding phenomenon and other environmental variations; therefore, the accuracy of the vision navigation system is hard to control.

Accordingly, the present invention proposes an embedded network-controlled omni-directional motion system with optical flow based navigation to overcome the abovementioned problems. The present invention utilizes an optical flow based navigation method, which is distinct from the conventional wheel navigation method, to position and navigate the motion system. The present invention not only can provide high-freedom mobility for robots or motion platforms but also can reduce the navigation cost of the system. Further, the control system of the present invention is integrated with the network to make the operation convenient and user-friendly.

### SUMMARY OF THE INVENTION

The primary objective of the present invention is to provide an embedded network-controlled omni-directional motion system with optical flow based navigation, wherein the navigation of the motion system does not adopts an expensive high-precision navigation device but utilizes an optical flow based navigation method, and thereby, the cost of the motion system can be reduced.

Another objective of the present invention is to provide an embedded network-controlled omni-directional motion system with optical flow based navigation, wherein the relative displacement with respect to the ground is not obtained from the reverse deduction with kinematics indirectly but is acquired with an optical flow based navigation method directly, and thereby, the calculation accuracy can be promoted.

Yet another objective of the present invention is to provide an embedded network-controlled omni-directional motion system with optical flow based navigation, wherein the relative velocity and displacement with respect to the ground is not calculated from the rotation speed of wheels indirectly but is acquired with an optical flow based navigation method directly, and thereby, the calculation results will not be influenced by the sliding movement of wheels.

Still another objective of the present invention is to provide an embedded network-controlled omni-directional motion system with optical flow based navigation, wherein the relative displacement with respect to the ground is not obtained via the computer-controlled device's detecting the environments but is directly acquired with an optical flow based navigation method, and thereby, the calculation results will not be influenced by either insufficient brightness or environmental variation.

Further another objective of the present invention is to provide an embedded network-controlled omni-directional motion system with optical flow based navigation, wherein the relative displacement with respect to the ground is not obtained from the conventional inertial navigation method but is implemented with an optical flow based navigation method, and thereby, the navigation accuracy will not be influenced by accumulated errors.

Further another objective of the present invention is to provide an embedded network-controlled omni-directional motion system with optical flow based navigation, wherein the omni-directional-wheel motion system replaces the parallel two-wheel motion system, and the motion system of the present invention can dexterously perform various motions in a narrow space, including in-situ rotation, translation together with rotation, and direct sideward translation.

Further another objective of the present invention is to provide an embedded network-controlled omni-directional motion system with optical flow based navigation, wherein the motion system of the present invention is integrated with a communication network to enable the operational interface thereof to be more convenient and human-friendly.

To achieve the abovementioned objectives, the present invention proposes an embedded network-controlled omni-directional motion system with optical flow based navigation, which comprises: a body, having multiple motion units to control the motion and driving of the body with each motion unit further comprising: an omni-directional wheel and a motor device; at least one optical flow sensor, installed on the ground-facing surface of the body, used to detect the motion state of the body, and creating optical flow detection data; and at least one embedded network control system, installed in the body, receiving motion instructions and transmitting optical flow navigation data via a communication network. Further, the motion system of the present invention can also be coupled to an information-processing unit and peripheral control devices to increase the operational convenience of the system.

In order to enable the objectives, technical contents, characteristics, and accomplishments of the present invention to be more easily understood, the embodiments of the present invention are to be described below in detail in cooperation with the attached drawings.

### BRIEF DESCRIPTION OF THE DRAWINGS

FIG. 1(a) and FIG. 1(b) are diagrams respectively showing the quadrature state of optical flow detection and the quadrature-mode output waveform according to the present invention.

FIG. 2 is a diagram schematically showing the motion and navigation architectures according to the present invention.

FIG. 3 is a diagram schematically showing the architecture of the control circuit according to the present invention.

FIG. 4 is a diagram schematically showing the architecture of the system integration according to the present invention.

FIG. 5 is a diagram showing the exemplification of the GUI window according to the present invention.

FIG. 6 is a diagram schematically showing the motion mode of in-situ rotation according to the present invention.

FIG. 7 is a diagram schematically showing the motion mode of heading straight according to the present invention.

FIG. 8 is a diagram schematically showing the motion mode of differential turning according to the present invention.

FIG. 9 is a diagram schematically showing the motion mode of translation according to the present invention.

FIG. 10 is a diagram schematically showing the motion mode of translation plus rotation according to the present invention.

### DETAILED DESCRIPTION OF THE INVENTION

When an object moves continuously, or when a camera moves with respect to an object, the pixels of the image of the object projected on a plane also has continuous displacement, and the relative speed of the displacement is the so-called optical flow. The so-called optical flow based navigation method is a method utilizing optical flow to position and navigate an object. As optical flow based navigation method can contrast an object with the environment and acquire the features of the object, it is unnecessary for optical flow based navigation method to understand the features of the object and the environments beforehand. Therefore, optical flow based navigation method is particularly suitable to sense and trace an object in a strange environment, and owing to such a characteristic, optical flow based navigation method is widely applied in various fields.

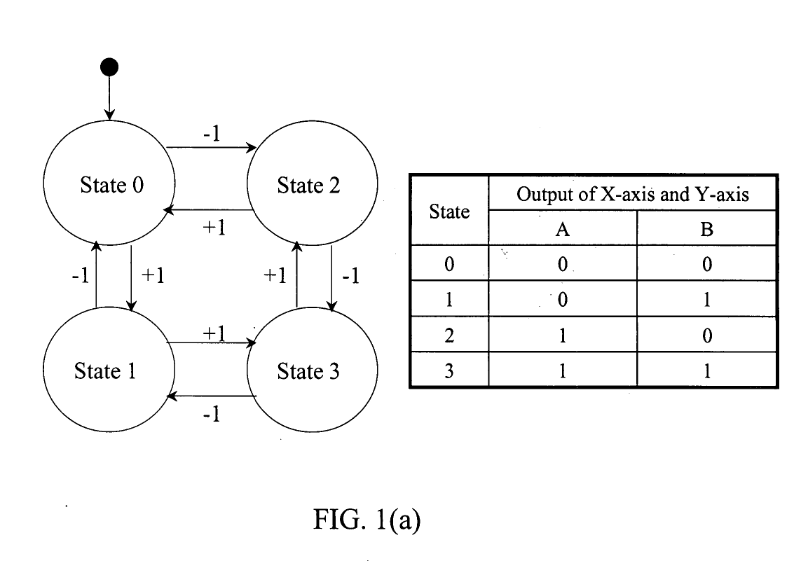

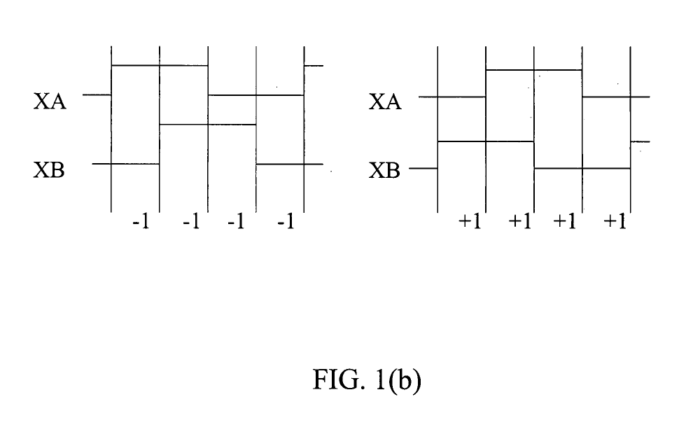

The principle of optical flow based navigation method is to be described in this paragraph firstly. The optical flow sensor used herein has a resolution of 800 pixels per inch, and the maximum displacement speed thereof is as high as 14 in. per second. Refer to FIG. 1(a) and FIG. 1(b) respectively showing the quadrature state of optical flow detection and the quadrature-mode output waveform, wherein the negative sign (−) denotes a leftward motion, and the positive sign (+) denotes a rightward motion. According to the information of FIG. 1(a) and FIG. 1(b), the motion information of the optical flow sensor with respect to X-axis and Y-axis can be obtained. Further, the motion information of the optical flow sensor can also be deduced from equations. Herein, two optical flow sensors are installed on different positions and used to detect the motion state of a motion system, including X-axis and Y-axis displacements and rotation with respect to Z-axis. From the relationship of the motion system and those two optical flow sensors, the following kinematic equations can be obtained:
V_{r,x}=V_{1,x}+wᵣ·r_{1,y} [1]
V_{r,x}=V_{1,y}−wᵣ·r_{1,x} [2]
V_{r,x}=V_{2,x}+wᵣ·r_{2,y} [3]
V_{r,y}=V_{2,y}−wᵣ·r_{2,x} [4]
wherein
V_{r,x} and V_{r,y} is the speed of the center of the motion system;
wᵣ is the angular speed of the motion system;
V_{i,x} and V_{i,y} is the speed of the ith optical flow sensor; and
r_{i,x} and r_{i,y} is the distance between the ith optical flow sensor and the center of the motion system. The equations [1], [2], [3], and [4] may be expressed by the following matrix-vector equation:

$$( \begin{matrix}10 - {r}_{1 , y} \\ 01 {r}_{1 , x} \\ 10 - {r}_{2 , y} \\ 01 - {r}_{2 , x}\end{matrix} ) ( \begin{matrix}{V}_{r , x} \\ {V}_{r , y} \\ {W}_{r}\end{matrix} ) = ( \begin{matrix}{V}_{1 , x} \\ {V}_{1 , y} \\ {V}_{2 , x} \\ {V}_{2 , y}\end{matrix} ) \qquad [ 5 ]$$

Least-square method is used to work out the translation speed and the rotation speed of the motion system, and then, the displacement and the rotation of the motion system are worked out via integration. The calculation results are:
θ_{robot}=∫(wᵣ)dt [6]
X_{robot}=∫(V_{r,x}cosθ_{robot}−V_{r,y}sinθ_{robot})dt [7]
Y_{robot}=∫(V_{r,x}cosθ_{robot}+V_{r,y}sinθ_{robot})dt [8]
wherein
θ_{robot} is the rotation of the motion system with respect to Z-axis;
X_{robot} is the displacement of the motion system along X-axis; and
Y_{robot} is the displacement of the motion system along Y-axis.

After the optical flow based navigation method has been discussed above, the hardware architecture of the present invention is to be described below. The embedded network-controlled omni-directional motion system with optical flow based navigation disclosed by the present invention has high-precision positioning capability; further, the motion system of the present invention not only can move omni-directionally but also can be controlled via a network platform. The system of the present invention utilizes optical flow to sense the images of the ground when the system is moving. Further, the system of the present invention cooperates with embedded network technology to achieve a low-cost and high-integration motion platform. The system of the present invention is primarily used in household robots and indoors-mobile robots. The present invention has three-freedom motion capability on a 2-dimensional surface, i.e. the abovementioned X-axis and Y-axis translations and Z-axis rotation. The present invention also utilizes embedded network technology to achieve dispersive calculation and far-end control. The embodiments of the present invention are to be described below in cooperation with the drawings.

In the architecture of the embedded network-controlled omni-directional motion system with optical flow based navigation of the present invention, multiple motion units, multiple optical flow sensors, and multiple embedded network control systems are installed on the body; the system is also externally coupled to an information-processing unit, and the user can input control instructions and related data from the external information-processing unit. The bi-directional transmission of motion instructions and optical flow detection data between the embedded network control system and the information-processing unit may be implemented with an Embedded-Ethernet (IEEE802.3), an Embedded-Wireless LAN (Wi-Fi, IEEE802.11a/b/g), an Ethernet network, a Bluetooth technology, or a UWB (Ultra Wideband) technology. The present invention may also utilize peripheral control devices to control the motion system of the present invention so that the control can be more convenient and human-friendly. Each abovementioned motion unit further comprises: an omni-directional wheel and a motor device. The abovementioned embedded network control system further comprises: at least one sensor-control unit, at least one motor-control unit, at least two network-control units, and at least one wireless-network transceiver unit.

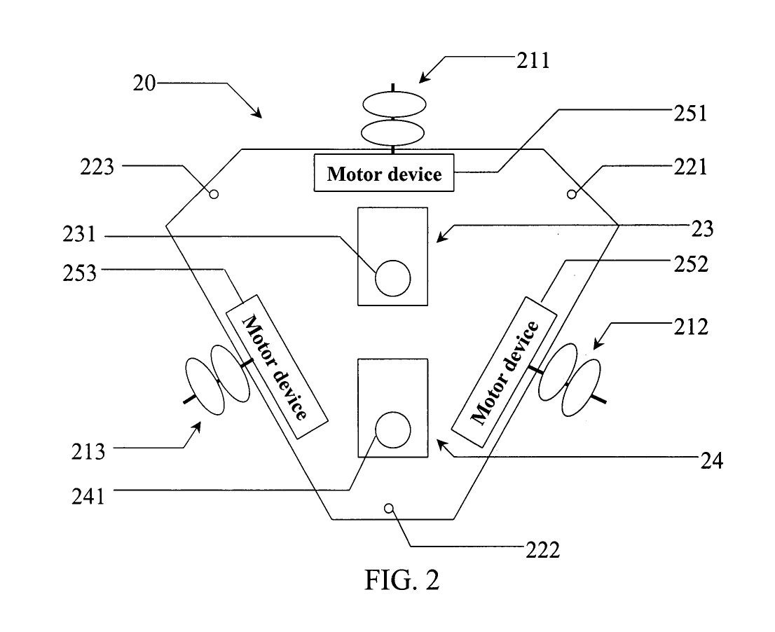

Firstly, the motion and navigation hardware architectures of the present invention are to be introduced. Refer to FIG. 2 a diagram schematically showing the motion and navigation architectures of the present invention. Three sets of omni-directional wheels 211, 212, and 213 are installed to the periphery of the body 20, and the angle contained by each two sets of omni-directional wheels is 120 degrees. Each of omni-directional wheels 211, 212, and 213 is coupled to one motor device 251, 252, or 253, and the motor devices 251, 252, and 253 are controlled by the PWM (Pulse Width Modulation) signals from micro-controllers (not shown in the drawings) and provide driving force for the body 20. Besides, two optical flow sensors 23, 24 are equipped with light sources 231, 241 and used to perform real-time positioning when the system is moving.

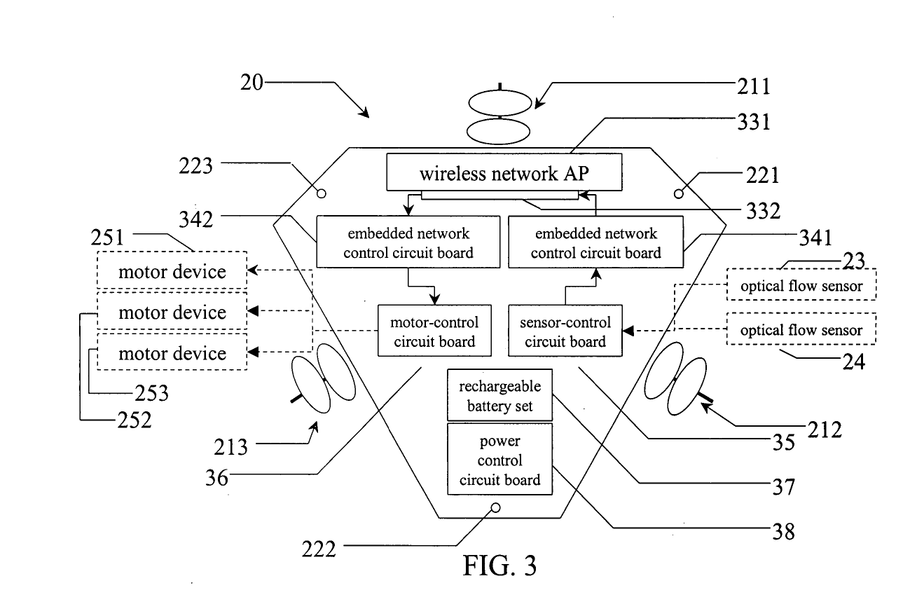

The abovementioned motion and navigation hardware architectures are controlled by the control circuit, which is also installed on the body 20. Refer to FIG. 3 for the architecture of the control circuit. The embedded network control system is also installed on the body 20 and further comprises: a wireless network AP (Access Point) 331, which has a switch hub 332; two embedded network control circuit boards 341, 342, respectively coupled to the switch hub 332; a motor-control circuit board 36, coupled to the embedded network control circuit board 342 and the motor devices 251, 252, and 253; a sensor-control circuit board 35, coupled to the embedded network control circuit board 341 and the optical flow sensors 23, 24; a rechargeable battery set 37, providing power for the system; and a power control circuit board 38, controlling the power supply for the entire system. In this embodiment, the motor devices 251, 252, and 253 and the optical flow sensors 23, 24 are disposed on planes different from the plane which the control circuit is disposed on, and dashed lines are used to denote this case. The embedded network control system installed on the body 20 may further be externally coupled to a personal computer (not shown in the drawings) or a wireless joystick (not shown in the drawings). A cover (not shown in the drawings) may also be used to protect the system from contaminants (such as dust) and damage; the cover is securely fixed to the body 20 at multiple fixing holes 221, 222, and 223 with appropriate fixing elements (not shown in the drawings); such a design also enables the body 20 to carry goods and have expansibility.

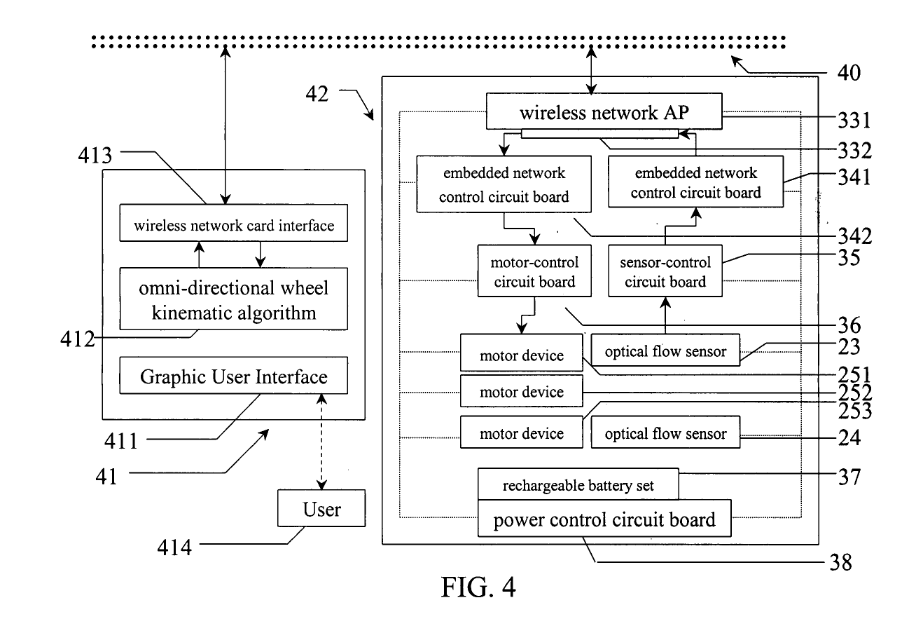

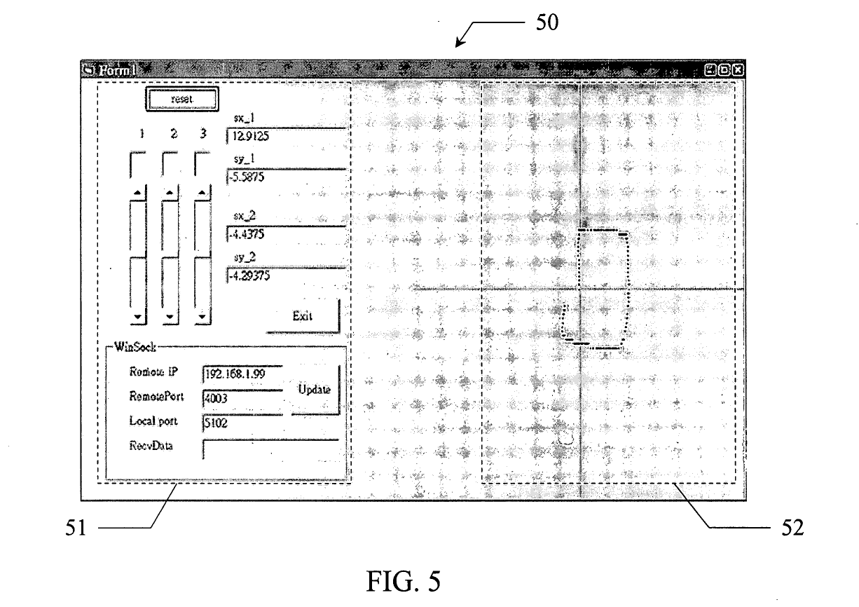

The hardwares regarding motion, navigation, and control have been described above, and the operational process is to be described below from the viewpoint of the user. Refer to FIG. 2 and FIG. 4, wherein FIG. 4 is a diagram schematically showing the system integration of the present invention. The external information-processing unit, which is usually a personal computer, has a robot agent program 41 providing a human-friendly GUI (Graphic User Interface) 411 for the user 414. FIG. 5 shows the exemplification of the GUI 411, wherein the left portion of the window 50 provides fields 51 for inputting control data, and the right portion of the window 50 shows the real-time track 52 detected by the optical flow based navigation method. The information-processing unit also has a sophisticated feedback-control algorithm, such as the omni-directional wheel kinematic algorithm 412. Refer to FIG. 2 and FIG. 4 again. The information-processing unit further has a wireless network card interface 413. When the user 414 inputs control instructions on GUI 411, the instructions will be calculated according to the omni-directional wheel kinematic algorithm 412, and the calculation results are to be used as the motion-control data for the body 20 and will be transferred via wireless network card interface 413 through the Embedded-Wireless LAN (IEEE802.11b/g) 40 to the embedded network control system 42 of the body 20.

The motion-control data, which has been sent from the information-processing unit to the wireless LAN (IEEE802.11b/g) 40, will be received by the embedded network control system 42 of the body 20. The transmission channel between the information-processing unit and the control system of the body 20 is full duplex for both sides, i.e. signals can be bi-directionally transferred between both sides, including the control signals input by the user in the information-processing unit and the position-related data sensed by the optical flow sensors 23, 24 of the body 20 when the body 20 is moving. The wireless network AP (Access Point) 331 receives the motion-control data from the information-processing unit and then transfers the motion-control data via the switch hub 332 to the embedded network control circuit board 342, which is coupled to motor-control circuit board 36. Cooperating with the motion and navigation architectures shown in FIG. 2, the motor-control circuit board 36 shown in FIG. 4 provides appropriate power for the motor devices 251, 252, and 253 to drive the omni-directional wheels 211, 212, and 213 so that the body 20 can move according to the motion-control data from the information-processing unit. When the body 20 starts to move, the optical flow sensors 23, 24, which are installed on the bottom surface of the body 20, begin to perform detection; meanwhile, the optical flow sensors 23, 24 transform positioning information into optical flow detection data and output the optical flow detection data to the sensor-control circuit board 35, and then, the optical flow detection data are transferred sequentially via the embedded network control circuit board 341, the switch hub 332, and then, the optical flow detection data is sent to the wireless LAN (IEEE802.11b/g) 40 by the wireless network AP (Access Point) 331; the optical flow detection data is to be fed back to the information-processing unit before the user 414.

Meanwhile, the wireless network card interface 413 of the information-processing unit will intercept the optical flow detection data, which is sent out by the control system of the body 20 and exists in the wireless LAN (IEEE802.11b/g) 40. The optical flow detection data will be processed with the omni-directional wheel kinematic algorithm and then presented on the GUI 411 in quantitative data and a motion track simultaneously, as shown in FIG. 5; thereby, the user can grasp the navigation information of the system in real-time and utilizes the navigation information as a reference to determine the succeeding motions of the system.

From those discussed above, it is known: in addition to the user-friendly control interface and the dexterous omni-directional wheels, the system of the present invention also utilizes the optical flow sensors to obtain the relative position in real-time when the system is moving, and the position information is fed back to the information-processing unit and calculated by the information-processing unit in order to present the position information on the operational interface in quantitative data and a motion track so that the user can clearly grasp the motion state of the system of the present invention.

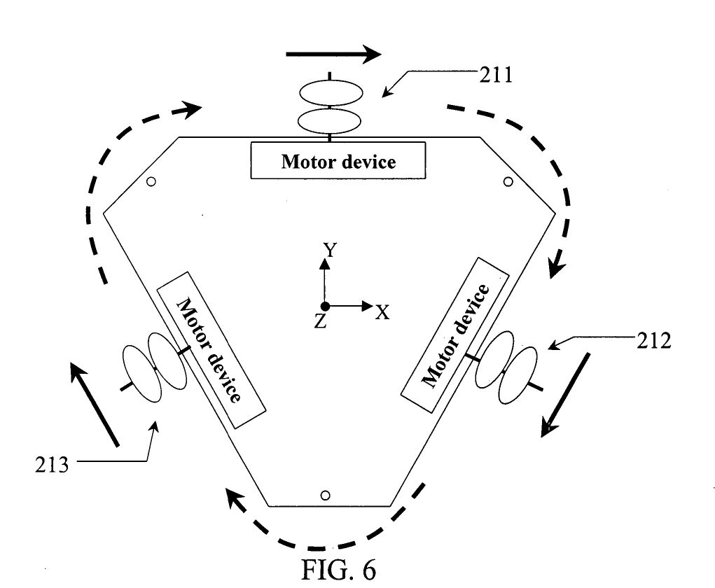

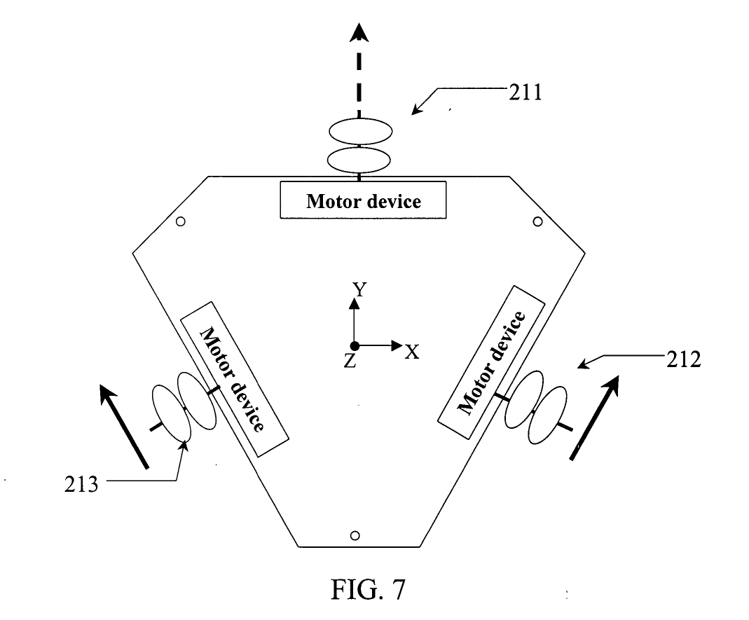

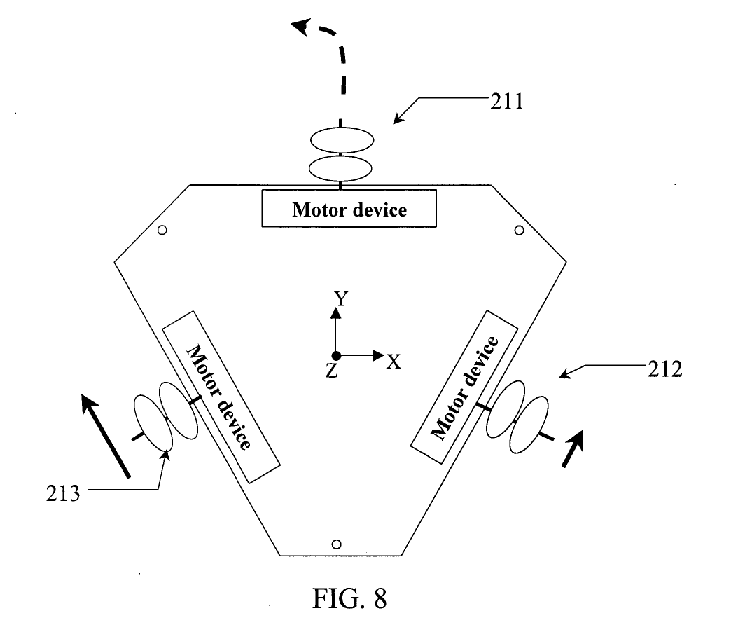

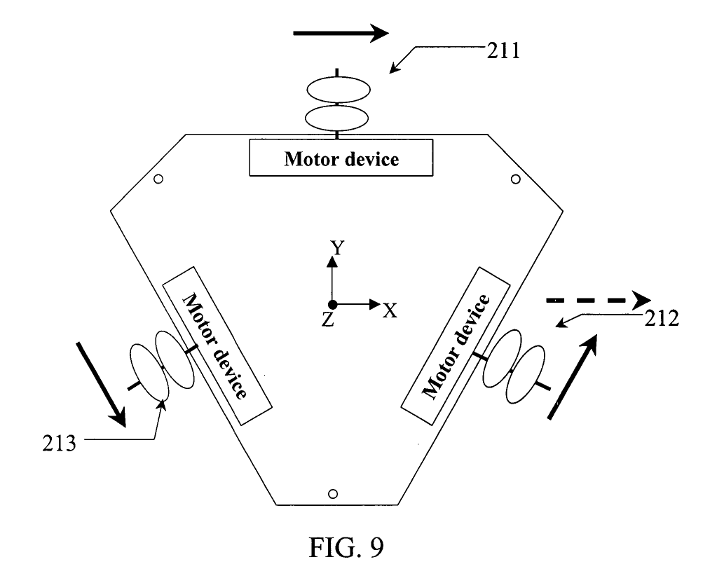

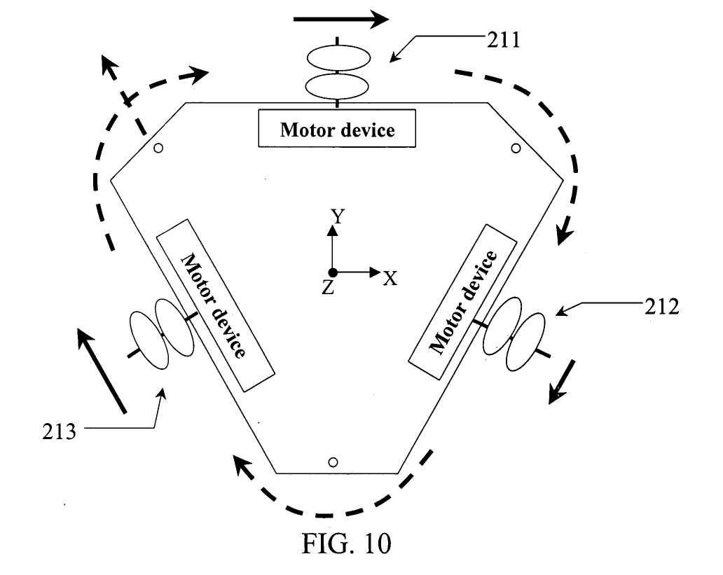

The above description and discussion should have enabled the structure and operation of the present invention to be clearly understood. Next, in cooperation with the drawings, the motion modes of the present invention will be further described below. The system of the present invention can utilize the omni-directional wheels to present five kinds of motion modes:
(1) In-situ rotation: Refer to FIG. 6. When the angular velocities of three omni-directional wheels 211, 212, and 213 are maintained equal and constant and the rotation directions thereof are also maintained identical (as shown by the solid lines), the motion system will rotate clockwise in situ (as shown by the dashed lines);
(2) Heading straight: Refer to FIG .7. When the omni-directional wheel 211 does not operate and the other two omni-directional wheels 212 and 213 rotate at the same angular velocity but at opposite directions (as shown by the solid lines), the motion system will head straight along the direction of the non-operating omni-directional wheel 211 (as shown by the dashed line);
(3) Differential turning: Refer to FIG. 8. Based on the abovementioned motion mode of heading straight but with those two rotating omni-directional wheels 212 and 213 having different angular velocities (as shown by the solid lines), the motion system will change the direction of the non-operating omni-directional wheel 211 and will make a turn (as shown by the dashed line), and such a motion mode is similar to the differential turning of general two-wheel motion systems;
(4) Translation: Refer to FIG. 9. The present invention can enable the component forces of those three omni-directional wheels 211, 212, and 213 to counteract mutually at a selected direction (as shown by the solid lines), and then, the system will translate along the direction vertical to the selected direction; therefore, the translation direction of the system of the present invention can be selected arbitrarily; the rightward translation shown in FIG. 9 (as shown by the dashed line) is only an exemplification of the translation motions; further, such a translation motion is a motion mode that two-wheel motion systems cannot achieve;
(5) Translation plus rotation: Refer to FIG. 10. Such a motion mode is the most complicated motion mode the system of the present invention can provide. The component forces of those three omni-directional wheels 211, 212, and 213 (as shown by the solid lines) are counteracted and accumulated to obtain the motion mode of translation plus rotation (as shown by the dashed line).

The embedded network-controlled omni-directional motion system with optical flow based navigation of the present invention not only can move along an arbitrary direction on a 2-dimensional plane but also can translate and rotate simultaneously. The high-precision optical flow based navigation method of the present invention utilizes the optical flow sensor, which is also used by the optical mouse, to replace the conventional complicated navigation system; therefore, the navigation of the present invention can achieve high precision without the penalty of high cost; further, the navigation technology used by the present invention is neither affected by environments nor influenced by wheel sliding. The motion system of the present invention is equipped with an embedded network control system and can be either near-end or far-end controlled via a wireless network; thus, the present invention has superior controllability. In the present invention, network technology is used to integrate an information-processing unit, which contains control programs, with the motion system; therefore, the calculation can be dispersed to the personal computer of the external information-processing unit. In the present invention, the information-processing unit not only has a user-friendly GUI (Graphic User Interface) but also may be integrated with peripheral control devices; therefore, the present invention has high control dexterity and superior hardware expandability. Accordingly, the present invention can be extensively and effectively applied to various fields, such as family, medicine, and industry.

Those embodiments described above are used to clarify the present invention in order to enable the persons skilled in the art to understand, make, and use the present invention; however, it is not intended to limit the scope of the present invention, and any equivalent modification and variation according to the structures, characteristics, and spirit disclosed in the specification is to be included within the scope of the present invention.

What is claimed is:

1. An omni-directional motion system with optical flow based navigation, comprising:
a body;
multiple motion units, installed to said body, and used to control the motion and driving of said body with each said motion unit further comprising:
an omni-directional wheel; and
a motor device, coupled to said omni-directional wheel, and providing driving force for said omni-directional wheel; and
at least one optical flow sensor, installed on the ground-facing surface of said body, used to detect the motion state of said body, and creating optical flow detection data.

2. The omni-directional motion system with optical flow based navigation according to claim 1, wherein said motion system may provide a motion mode of in-situ rotation.

3. The omni-directional motion system with optical flow based navigation according to claim 1, wherein said motion system may provide a motion mode of heading straight.

4. The omni-directional motion system with optical flow based navigation according to claim 1, wherein said motion system may provide a motion mode of differential turning.

5. The omni-directional motion system with optical flow based navigation according to claim 1, wherein said motion system may provide a motion mode of translation.

6. The omni-directional motion system with optical flow based navigation according to claim 1, wherein said motion system may provide a motion mode of translation plus rotation.

7. The omni-directional motion system with optical flow based navigation according to claim 1, wherein multiple microcontroller units are used to respectively control the rotation directions and rotation speeds of said motor devices.

8. The omni-directional motion system with optical flow based navigation according to claim 7, wherein said microcontroller units utilizes an omni-directional wheel kinematic algorithm to control the rotation directions and rotation speeds of said motor devices.

9. An embedded network-controlled omni-directional motion system with optical flow based navigation, comprising:
a body;
multiple motion units, installed to said body, and used to control the motion and driving of said body with each said motion unit further comprising:
an omni-directional wheel;
a motor device, coupled to said omni-directional wheel, and providing driving force for said omni-directional wheel; and
at least one optical flow sensor, installed on the ground-facing surface of said body, used to detect the motion state of said body, and creating optical flow detection data; and
at least one embedded network control system, installed on the upper surface of said body, receiving motion-control data and feeding back said optical flow detection data via a communication path of network.

10. The embedded network-controlled omni-directional motion system with optical flow based navigation according to claim 9, further comprising:
at least one sensor-control unit, coupled to said optical flow sensors, and used to transmit said optical flow detection data created by said optical flow sensors;
at least one motor-control unit, coupled to said motor devices, and used to receive said motion-control data and control said motor devices;
at least two embedded network control units, respectively coupled to said sensor-control unit and said motor-control unit, transmitting said motion-control data to said motor-control unit, and receiving said optical flow detection data from said sensor-control unit; and
at least one wireless network transceiver unit, coupled to said embedded network control units via a switch hub, providing a network communication path for transmitting said motion-control data and said optical flow detection data.

11. The embedded network-controlled omni-directional motion system with optical flow based navigation according to claim 9, wherein said embedded network control unit may be directly linked to an information-processing unit, and said optical flow detection data and said motion-control data are transferred therebetween; said optical flow detection data and said motion-control data are also processed and stored in said information-processing unit.

12. The embedded network-controlled omni-directional motion system with optical flow based navigation according to claim 11, wherein said information-processing unit utilizes an omni-directional wheel kinematic algorithm to process related data.

13. The embedded network-controlled omni-directional motion system with optical flow based navigation according to claim 11, wherein said information-processing unit may be a personal computer or a personal digital assistant.

14. The embedded network-controlled omni-directional motion system with optical flow based navigation according to claim 9, wherein a peripheral control device may be used to control said motion system.

15. The embedded network-controlled omni-directional motion system with optical flow based navigation according to claim 14, wherein said peripheral control device may be a wired remote control device or a wireless remote control device.

16. The embedded network-controlled omni-directional motion system with optical flow based navigation according to claim 10, wherein said wireless network transceiver unit may be a wireless network access point.

17. The embedded network-controlled omni-directional motion system with optical flow based navigation according to claim 9, wherein said communication path of network may be an Ethernet network, an Embedded-Ethernet (IEEE802.3), an Embedded-Wireless LAN (Wi-Fi, IEEE802.11a/b/g), a Bluetooth technology, or a UWB (Ultra Wideband) technology.

18. The embedded network-controlled omni-directional motion system with optical flow based navigation according to claim 9, wherein said motion system may provide a motion mode of in-situ rotation.

19. The embedded network-controlled omni-directional motion system with optical flow based navigation according to claim 9, wherein said motion system may provide a motion mode of heading straight.

20. The embedded network-controlled omni-directional motion system with optical flow based navigation according to claim 9, wherein said motion system may provide a motion mode of differential turning.

21. The embedded network-controlled omni-directional motion system with optical flow based navigation according to claim 9, wherein said motion system may provide a motion mode of translation.

22. The embedded network-controlled omni-directional motion system with optical flow based navigation according to claim 9, wherein said motion system may provide a motion mode of translation plus rotation.

23. The embedded network-controlled omni-directional motion system with optical flow based navigation according to claim 9, wherein multiple microcontroller units are used to respectively control the rotation directions and rotation speeds of said motor devices.

24. The embedded network-controlled omni-directional motion system with optical flow based navigation according to claim 9, wherein said microcontroller units utilize an omni-directional wheel kinematic algorithm to control the rotation directions and rotation speeds of said motor devices.
